(19) United States
(12) Patent Application Publication
(10) Pub. No.: US 2024/0313490 A1
(43) Pub. Date: Sep. 19, 2024

(54) METHOD FOR CRIMPING A CRIMP ELEMENT TO A CONDUCTOR, CRIMP DEVICE, CONTROL UNIT AND MACHINE-READABLE PROGRAM CODE

(71) Applicant: MD Elektronik GmbH, Waldkraiburg (DE)

(72) Inventors: Josef OHNI, Kraiburg am Inn (DE); Peter A. WOLFMEIER, Garching an der Alz (DE); Martina OSSNER, Geisenhausen (DE)

(21) Appl. No.: 18/583,728

(22) Filed: Feb. 21, 2024

(30) Foreign Application Priority Data
Mar. 13, 2023 (EP) 23 161 522.0
Apr. 5, 2023 (EP) 23 166 743.7
Jan. 17, 2024 (EP) 24 152 455.2

(51) Int. Cl. H01R 43/048; H01R 43/058

(52) U.S. Cl. CPC H01R 43/0486; H01R 43/058

(57) ABSTRACT

Embodiments herein relate to a method for crimping a crimp element to a conductor by a crimp device comprising a crimping tool a crimp anvil, whereas at least one time-based signal is detected relating to the crimping process performed by the crimp device, whereas the at least one time-based signal is analysed by applying the at least one time-based signal to a trained neural network, whereas the trained neural network is configured to classify a result of a crimping process based on the received at least one time-based signal, whereas a classification result comprising at least a class corresponding to a non-defective crimp result and a class corresponding to a defective crimp result is provided, especially by the trained neural network, based on the classification performed by the trained neural network, whereas a control signal is generated and provided as output based on the determined classification result.

### TECHNICAL FIELD

The invention relates to a method for crimping a crimp element to a conductor, a crimp device configured to perform that method, a respective control unit and machine-readable program code.

The present invention is mainly described in connection with data cables. It is understood that the present invention can be used for any type of cable.

### STATE OF THE ART

When manufacturing data cables, the cables are usually processed in an automated processing plant and, for example, assembled, i.e., cut to the appropriate length and provided with appropriate electrical contacts and/or connectors.

The invention relates specifically to crimp devices and a respective crimping process, especially for such cables. During such a crimping process a crimp element, typically a crimp barrel or a crimp sleeve, which can have a variety of embodiments, is connected to a conductor of a cable, especially to strands, by crimping.

Crimping is as process of joining two pieces of metal or other materials by cold deformation of one or both of these pieces to create a mechanical connection between them. Crimping is realized by using a crimp device comprising a crimping tool and a crimp anvil. The two pieces to be connected are pressed or squeeze together between the crimping tool and the crimp anvil to create a secure mechanical connection. In case of cables often crimping is not only used to establish a mechanical connection but also an electrical connection between the two pieces.

To control the crimping process in a better way typically crimping dies are used by the crimping tool and/or the crimp anvil, which shall provide defined conditions during the actual crimping process. The crimping dies may provide a specific shape or pattern in the material, such as a series of ridges or grooves, which helps to lock the pieces together and prevent them from separating.

Crimping is commonly used in a wide range of applications, especially in electrical wiring. In electrical wiring, for example, crimping is used to attach connectors to wires, creating a secure and reliable connection.

To maintain a continuous quality for the crimping process the crimping process needs to be controlled. In the past this was often realized by an offline manual monitoring of the crimping process by analysing the manufactured crimped connection. Especially grinding images have been used to acquire knowledge if a crimped connection satisfies the desired quality requirements.

In addition, crimping parameter are regularly checked, e.g. like crimping height, are regularly checked during the manufacturing process, especially when the crimping conditions were changed in a controlled manner, e.g. from the processing of a first set of crimp elements to a second set of crimp elements or the crimping dies have been exchanged.

However, such manual monitoring of the crimping process is burdensome and the reaction time from defectively manufactured crimped connections to actively improve the manufacturing process is high.

Attempts have been made to improve such monitoring of the crimping process e.g. by applying automatic crimp force monitoring comparing detected time-based crimp force signals with a reference signal curve for time-based crimp force signals. Further attempts utilize e.g. image based analysis methods.

Such image-based analysis method for manufactured crimped connections is e.g. known from DE 102019107687 A1 disclosing a method for ensuring and/or checking the quality of a crimping using a crimping machine for crimping a cable with a contact sleeve and using a first optical sensor for detecting and/or recording first image data of the contact sleeve and using an evaluation electronics system, comprising the following steps: the first image data of the contact sleeve are detected by the first optical sensor; the evaluation electronics system carries out a first comparison of the first image data of the first optical sensor with first reference data of a predetermined contact sleeve, and the first comparison is checked for the presence of a predetermined first criterion; if the predetermined first criterion is satisfied, a first signal is output; wherein the detection of the first image data and the first comparison and the checking of the first criterion and the output of the first signal are carried out before the cable is crimped with the contact sleeve.

Firstly, image processing programs based on classic rule-based object recognition are often inflexible and complex, and in some cases very difficult to implement reliably.

Secondly, in manufacturing environments creating a significant amount of dust and dirt, image-based solutions lead to challenges in terms of maintaining reliable image acquisition conditions to enable a reliable analysis of crimp results.

### DESCRIPTION OF THE INVENTION

It is the object of the invention to provide a solution for a reliable, efficient, and robust assessment of a crimping process, especially of a crimping result, during the operation of a crimp device, especially in real-time.

The object is solved by the features of the independent claims. Advantageous further embodiments of the invention are indicated in the dependent claims, the description, and the accompanying figures. In particular, the independent claims of one claim category may also be further developed analogously to the dependent claims of another claim category. Further embodiments and further embodiments are provided by the independent claims as well as by the description with reference to the figures.

The present invention relates especially to a method for crimping a crimp element to a conductor by a crimp device comprising a crimping tool and a crimp anvil, whereas at least one time-based signal is detected relating to a crimping process performed by the crimp device, whereas the at least one time-based signal is analysed by applying the at least one time-based signal to a trained neural network, whereas the trained neural network is configured to classify a result of a crimping process based on the received at least one time-based signal, whereas a classification result comprising at least a class corresponding to a non-defective crimp result and a class corresponding to a defective crimp result is determined, especially by the trained neural network, based on the classification performed by the trained neural network, whereas a control signal is generated and provided as output based on the determined classification result.

This method provides a robust and reliable way to assess a result of a crimping process. Especially, this method can be utilized for real-time monitoring of the crimping process. The method is especially robust, as an image-based monitoring and/or analysis can be avoided.

The crimping tool can comprise a crimping tool front end. The crimping tool front end can be partly modified by exchangeable crimping dies adapted to a special crimping task or special crimp element. Further the crimping tool may comprise a crimp press, which presses the crimping tool front end on the crimp element, which is typically arranged on a crimp anvil during the crimping process. Further a conductor is present, which shall be connected to the crimp element by crimping. The conductor is typically part of cable. The cable, the crimp element, as well as the conductor may have different configurations.

The crimping tool front end and the crimp anvil may interact such that by pressing the crimping tool front end to the crimp anvil, a crimp element and the conductor positioned between the crimping tool and the crimp anvil are connected by cold deformation of the crimp element. This deformation is suitable to connect the crimp element to the conductor mechanically, but also electrically.

Crimp elements are the elements that shall be attached to a certain structure, e.g. a conductor, by crimping. Crimp elements may especially comprise crimp barrels or crimp sleeves. There is a high variety of different crimp elements e.g. dependent on the configuration of the conductor they shall be attached to, on the configuration of the cable and its purpose and on the manufacturing process following the crimping process.

According to the method at least one time-based signal is detected relating to the crimping process. The crimping process comprises especially the time period in which a crimp element is crimped by the crimp device. As a ‘time-based signal’, a temporal course of a signal shall be understood.

In context of the invention the signal is a detected signal for a defined period of time by a specific detecting unit, typically a sensor enabled to detect time-based signal, i.e. a temporal course of a signal.

The method is suitable to be performed with more than one time-based signal, especially with time-based signals detected by different sensors, wherein the sensors may be of the same or of different type. Time-based signals may be of different type. Respectively, the sensors for time-based signals of different type are considered to be of different type. This means time-based signals of different types correspond typically to different physical variables. This applies correspondingly to the different types of sensors. E.g. a time-based position signal is a different signal type compared to a time-based force signal or compared to a structure-borne sound signal. For detecting such different types of time-based signals, typically different types of sensors are used.

By considering a plurality of time-based signals, especially of different types, the accuracy of the assessment of the crimping result can be increased.

It has shown that one time-based signal is already sufficient to determine a sufficiently reliable classification result for connection of the crimp element and the conductor based on the time-based signal captured during its production. Such classification result provides at least the information, if a result of a crimping process is assessed to be defective or non-defective.

As such at least one time-based signal generated by a specific crimping process, which especially comprises the contact phase of the crimping tool and the crimp element, is closely related to the underlying crimping process, such time-based signal is a suitable basis for determining a classification result of a crimping process generating such at least one time-based signal.

It has shown that such at least one time-based signal related to the crimping process can be used to assess the crimping result derived by the crimping process to which the time-based signal is related.

This is achieved by applying the at least one time-based signal to a trained neural network, whereas the trained neural network is configured to classify a result of a crimping process based on the received at least one time-based signal, whereas a classification result comprising at least a class corresponding to a non-defective crimp result and a class corresponding to a defective crimp result is determined, especially by the trained neural network, based on the classification performed by the trained neural network, whereas a control signal is generated and provided as output based on the determined classification result.

Conventional signal analysis of at least one time-based signal of the crimping process is not successful in relating an assessment of a crimp result to the at least one conventionally analysed time-based signal. Therefore, the invention envisages to make use of a respectively trained neural network, especially a deep neural network (Deep Neural Network, DNN), especially a deep recurrent neural network (Deep Recurrent Neural Network, DRNN) or a deep convolutional neural network (Deep Convolutional Neural Network, DCNN), which is applied to the at least one time-based structure-borne sound signal or to the at least one time-based force signal, respectively.

The trained neural network is configured to classify a result of the crimping process, especially a crimped connection, on basis of the provided at least one time-based signal. Based on that at least one time-based signal trained neural network performs a plurality of classification tasks. Based on the results of these classification tasks, a classification result comprising at least a class corresponding to a non-defective crimp result and a class corresponding to a defective crimp result is provided.

Such classification result can also be provided by the trained neural network; however such classification result may also be generated outside of the trained neural network, e.g. by rule-based and/or logic approach. In any way the determined classification result of being a defective crimp result or a non-defective crimp result is based on the classification performed by the trained neural network.

The term crimp result is not restricted to the actual connection of the crimped crimp element and the conductor, but it can further comprise other results of the crimping process that do not specifically relate to the properties of the crimped connection. E.g. the term crimp result further comprises the assessment in terms of the situation, if a crimping process can be performed or not due to presence or absence of a conductor or a crimp element. The term defective or non-defective may therefore also be used as classification term for the crimp process and not only to the crimped connection of connector and crimp element.

The trained neural network may utilize a recurrent neural network, as such recurrent neural network is of advantage for time-based signal analysis as such a recurrent neural network is enabled to consider signals of the past. Also, a convolutional neural network may be used advantageously, as the convolutional kernels can be configured such to detect certain structures of interest in a time-based signal. A combination of recurrent und convolution neural network may also be considered, especially of a deep recurrent und convolution neural network, to combine the advantages of both neural network approaches. It is understood that also other kind of neural networks may be used for the classification.

The trained neural network is configured by training to classify the time-based signal provided to the trained neural network and to provide a respective classification result based on the classified time-based signal. Such trained neural network showed reliable and robust classification results in terms of the at least one time-based signal provided to the trained neural network.

The classification result provided by trained neural network at least comprises the information, based on the analysis of the time-based signal, that a connection of the crimp element and the conductor is classified as non-defective or defective. The classification result can comprise further information related to the crimping process, respectively to the associated crimping result. Especially, an output vector can be provided by the neural network providing additional information on the crimping process.

Thus, the present invention makes use of a specially trained artificial neural network performing a fault pattern recognition based on the at least one time-based signal using the appropriately trained neural network.

The neural network is trained by means of corresponding training data sets. Such training data sets are at least a plurality of time-based structure-borne sound signals, whereas an associated crimp result is known. Dependent on the intended use, also other types of time-based sensor signals may be used for training.

In the course of such training, the trainable neural network may be presented with corresponding training data which has already been divided in advance into positive training examples, e.g. a time-based signal resulting in a non-defective crimp result, and negative training examples, e.g. a time-based signal resulting in a defective crimp result. Further, the training data also comprises a corresponding classification result. As mentioned, the classification result may comprise an information, if a crimp result based on the associated at least one time-based signal is a defect or non-defect crimp result.

Further the classification result may comprise more detailed information regarding the crimping process, e.g. information to the quality of the crimp result, a certain defect or other information. The information that shall be output by the trained neural network when analysing a time-based signal needs to be provided to the neural network in the training phase.

Such a training dataset may, for example, be generated manually from historical data, for which the time-based signal was detected and the crimp result, especially defective or non-defective, but e.g. also the error pattern of a defective connection of crimp element and conductor, is known. The time-based signals required for training can be derived easily as the crimping process can be monitored and the respective data is normally stored. Further, the result of the crimping process is known.

In the following, an exemplary embodiment for the creation of a training data set and the training of the neural network is described. It is understood that the described creation and training of the neural network may also be performed independently, especially offline at a separate computer that is not related to any manufacturing or crimping process. The present disclosure therefore explicitly discloses such creation and corresponding training as separate subject matter.

For an exemplary training of a neural network, at least 500 to 2000 time-based signals for single crimp processes are used to train a specific classification result.

If a plurality of different time-based signals, e.g. from different sensors, especially different types of sensors for detecting different types of time-based signals, the number of training data sets increases accordingly.

I.e. the size of the training data set is typically dependent on the number of classification results that shall be provided by the trained neural network as well as on the number and types of time-based signals that shall be used by the neural network to determine the classification result.

Respectively, a training providing a low level of training effort is e.g. based on a time-based force signal and/or on a time-based structure-borne sound signal and a classification result relating to the crimp result which shall only comprise the information “defective” or “non-defective”.

The analysis of time-based signals, especially of time-based force signals and/or structure-borne sound signals, by a trained neural network is dependent from different factors, e.g. the type of the time-based signal, number of data points comprised by the time-based signal, the desired accuracy and the computational resources.

It is advantageous to pre-process the time-based signal, e.g. the time-based force signal and/or the structure-borne sound signal or a plurality or combination of different time-based signals, before they can be analysed by the neural network. Such pre-processing may comprise normalization, scaling, and filtering data, especially to remove noise and/or artefacts. The pre-processing of the time-based signals to be analysed by the neural network may be performed by the neural network or may be performed conventionally, i.e. without applying a neural network for the pre-processing.

Further the data should preferably made available to the neural network in such way that they can be processed by the neural network. This is valid for applying the trained neural network to at least one time-based signal related to the crimping process, but as well for the training of an untrained or partially trained neural network with respective training data.

Normally, the time-based signals are windowed in different time windows to capture the time dependency of the time-based signal. This can be implemented e.g. by so called rolling windows, which provide a fixed time window to capture a time-based signal step by step.

The determined signal windows may then be organized in a respective matrix. Typically, each line of the matrix corresponds to a signal window, whereas each column corresponds to a point of time in this respective window. The size of the window and the overlap of the time windows can vary.

Out of this matrix, vectors can be generated to provide input data for the neural network. E.g. each vector can comprise the signal of each window in one line of the matrix. In such case each line of the matrix would be an input vector for the neural network.

If a recurrent neural network is used, the rolling windows is typically provided as sequence of vectors. Each vector corresponds to one signal window. The signal windows are then provided subsequently to the neural network, whereas the neural network generates an output which is used as input for the next signal window.

Further the training data may comprise further data beyond at least one time-based signal, especially beyond a plurality of time-based signals of different types. For example such further data to be included in the analysis by the neural network may related to the technical specification of the crimp device, the used material of the crimp element, if known, the used crimping tool and, and other, especially technical, parameters associated with the crimping process.

Further it may be considered for training of the neural network to manipulate the measured time-based signals in such way that a classification result is not changed but the parameter room for which the neural network is trained is increased. This allows more reliable, robust, and stable operation of the trained network when applied to at least one to time-based signals relating to the crimping process as the network is enabled to handle variations, which were not contained in the unmanipulated training data.

After respective preparation of the time-based signal or plurality of time-based signals, the neural network is trained with a share of the training data sets, e.g. 66%. The remaining training data sets, e.g. 34%, are used to later check the performance of the neural network, i.e. the time-based signal of these training data sets is provided to the trained neural network and the classification result is checked versus the known crimp result. This share of training data may also be denoted as test data or verification data. This approach is used to avoid overfitting.

After the training is finalized the quality of the training may be determined by feeding the test data to the trained neural network. In case the quality of the classification results is sufficiently accurate, the training is stopped. In case the classification results do not reach the desired accuracy level the training can be continued with respective training data and/or be started with amended parameters.

It needs to be understood that the training can be implemented in different ways dependent on the utilized neural network. Basically, each kind of training of the neural network adapts the internal weights of the neural network in such way, that the deviation of the classification result to the known result from the training data is minimized. This is typically implemented by the so-called backpropagation optimization of the neural network.

For the training, a so-called epoch number can be determined as well as an abortion criterion. The epoch number reflects the number of training cycles. For each training cycle a defined number of training data can be used, e.g. the entire training data or a subset of the training data. The abortion criterion determines the acceptable deviation of the classification result from the ideal, respectively known, result. In case the abortion criterion is reached, the training is stopped, and the neural network is considered as sufficiently well trained.

The usable trained neural network, especially a deep recurrent neural network, may comprise an input layer, a plurality of hidden layers and an output layer. The hidden layers may comprise at least partly identical layers or repeating layer structures. Especially the neural network may comprise several processing blocks dedicated to a specific task.

In the following a schematic layout of the neural network is described.

In the input layer, the time-based signal or plurality of time-based signals are provided to the input layer of the neural network. Furthermore, other data or parameters that influence the crimping process may be provided to the input layer in combination with the time-based signal or the plurality of time-based signals, especially of different types.

The other data provided to the neural network can be machine parameter, providing e.g. positions, velocities, used die for a crimping tool front end, known material parameters of the crimp element. In addition, further parameters might be considered as input for the neural network that are e.g. of importance for subsequent manufacturing steps of the crimped connection.

After the input, several processing blocks can be considered for processing the input data. Such blocks can comprise a pre-processing of input data for the respective block, e.g. the input data can be pre-processed in terms of time-wise normalization or amplitude. The windowing of the time-based signal can be varied; further a sub-sampling of the time-based signal can be provided to reduce the signal without losing information, e.g. to cancel noise or other defined frequency ranges. It is further possible to determine a root mean square, especially without filtering, which is a measure for the amplitude over a certain time period. Also, a principal component analysis can be provided to reduce the dimensions of the data, but to keep characteristic information in the data set. E.g. also zero padding layer can be provided, a layer for convolutional operations, a layer for normalization, layers for activation via a so-called ReLU function, also denoted as rectified linear unit, can be utilized and others.

The pre-processing can be provided by the neural network, if specifically trained for that task. However, the pre-processing of data may also be performed outside the neural network with a conventional method.

For the classification task itself different tools can be utilized, whereas the use of the respective tool can depend on the actual task that shall be performed on the data.

For example, HDBSCAN, which is an abbreviation for hierarchical density-based spatial clustering of applications with Noise, can be used. This is a clustering algorithm, which is used to identify clusters in a data set comprising complex data structures. Such identified clusters can be used for further analysis by other processing blocks.

A one-class support vector machine, abbreviated OCSVM, can be used to identify anomalies from the operation data, i.e. based on the at least one time-based signal, of the crimp device. The anomaly detection is based on the training data which is defined as non-anomaly data. An anomaly is detected, if analysed data is sufficiently distant in the data room from the training data. This approach allows to detect anomaly events, especially heavy or severe anomalies in the crimping process, without having information or training data on a respective anomaly. This can also be provided by HDBSCAN in isolation or by a combination of OCSVM and HDBSCAN, whereas the combination of OCSVM and HDBSCAN further improves an anomaly detection. Especially, anomalies are typically rare and normally not sufficient training data is present to detect anomalies by training with anomaly data. With this tool, it is possible to detect heavy or severe anomalies in the operation of the crimp device without training data for the anomaly itself.

Another suitable tool that can be applied is a traditional support vector machine. By means of a support vector machine the classification in a plurality of classes can take place as given by the training data. Such tool can be used for a processing block which classifies certain defects within a group of defects trained to the neural network.

Another helpful approach can be a forest of randomized decision tree, also called random forest. This is an ensemble model in the field of machine learning that combines multiple decision trees, each trained on a different subset of the training data and makes predictions based on the collective output of these trees. Each decision tree is trained randomly. The decision trees in a random forest are constructed using a random subset of features and a random subset of the training data. This helps to reduce overfitting and increase the diversity of the trees in the forest. This leads to model which is more robust and generalizes in a better way on unlearned data. During training, the algorithm constructs a large number of decision trees and aggregates their outputs to make the final prediction. The random forest approach is of advantage in case of missing training data. It provides a high accuracy and is easy to implement.

Another advantageous approach is using an extreme learning machine, abbreviated ELM, within the processing blocks of the neural network. ELM is a supervised machine learning model to generate an output based on a certain input and belongs to the family of feedforward neural networks. ELMs have the special configuration that neurones of a hidden layer are randomly initialized, followed by a linear regression to adapt the output of the hidden layer to the desired output vector. In contrast to traditional neural networks, whose weights are optimized in an iterative way, the weights of an ELM are adapted much faster, typically in one step. ELMs are typically easer to implement and to train than traditional feed forward neural networks.

An exemplary ELM to implement the invention used one hidden layer of tan h (tangens hyperbolicus)-activated ELM neurons and further neurons copying the input. The input layer comprised 500 neurons, the hidden layer comprised 256 neurons with tan h-activation and copying neurons. The output layer comprised one neuron.

Another approach that can be used in context of the invention is the use of a multilayer perceptron, abbreviated MLP, which is also a supervised-machine learning model, typically utilized for classification and regression problems. An MLP is a specific embodiment of a feed forward neural network. An MLP comprises at least an input layer, an output layer and at least one hidden layer, typically a plurality of hidden layers, arranged between input layer and output layer. Each neuron in one layer is connected to all neurons of a following layer, however not with neurons of the same layer.

In an MLP the input values are guided from the input layer to the at least one hidden layer to the output layer. Each neuron in a hidden layer uses a weighted sum of its inputs and outputs a value dependent on the sum of inputs and the applied activation function. By training on the training data, the weights of the connected neurons are adapted such that the deviation from the known result and the result provided by the MLP is minimized. Typically, this is implemented via a backpropagation algorithm.

It has shown that the invention can be realized by using several processing blocks comprising an input layer of more than 500 neurons, 4 hidden layers, whereas the first layer comprises 256 neurons with a ReLU activation, the second hidden layer comprises 64 neurons with a ReLU activation, the third hidden layer comprises 16 neurons with a ReLU activation and a fourth hidden layer of 4 neurons with ReLU activation and an output layer comprising 1 neuron.

The approaches and tools described above can be used single or in combination to implement specific functionalities of a processing block, respectively to implement an embodiment of the invention.

The trained neural network may be configured such that following process is realized.

After the input of the data, an analysis of machine and sensor parameters can be provided to identify heavy failures in the process.

The provided input data can then be processed by the trained neural network to classify the crimp result on the provided input data. The neural network may comprise different functional blocks to perform different tasks on the input data.

A first functional block may concern an anomaly detection. There may also be a plurality of functional blocks for anomalies, e.g. a first block concerned with the detection of heavy anomalies and second block concerned with the detection of light anomalies. These can e.g. be implemented by utilizing the one-class support vector machine.

Another functional processing block may assess the feed adjustment for the element to which the crimp element shall be crimped. A further functional processing block may assess the presence of the cable, respectively the conductor, in the crimp device. Another functional processing block may assess the cable feeding position based on the input signal. Another functional processing block may assess the complete capture of the strands during the crimping process based on the input signal. A further functional processing block may assess a crimp height adjustment. Another functional processing block may assess the crimp height and/or crimp width.

The results of these functional processing blocks may then be assembled to the classification result of a defective crimp result or a non-defective crimp result. This can e.g. be done via another processing block of the neural network or by logical combination of the results provided by the respective previous functional processing blocks of the neural network.

Further an output vector can be provided with additional information, e.g. regarding the kind of the determined defect. This output vector may also comprise the reporting of the functional blocks from which results were provided, especially the respective results of these functional blocks.

The outputs of the pre-processing processing blocks and the classification processing blocks may be combined as linear combination with weights from the input and/or can be processed by other functional blocks comprising machine learning algorithms to generate the output.

Based on the result of the classification a control signal is generated and provided as output. Such control signal can be used to provide information on the classification result to user interface, e.g. a display or monitor. Further the control signal can be used as input signal for a control unit to control the crimp device based on the provided control signal.

In an embodiment the at least one time-based signal comprises a time-based force signal related to the force applied to a crimp element by the crimping tool, whereas the at least one time-based force signal is detected for a defined time period comprising a contact phase of the crimping tool and the crimp element. By monitoring the temporal course of a force signal related to the crimping force another valuable parameter is utilized highly relevant for the crimping process and the crimping result. Especially the force signal provides a temporal course of the force during the contact phase of the crimping tool and the crimp element. The phase of contact of the crimping tool and the crimp element is especially critical for the crimping process and its result. For this reason, time-based signals covering this period are especially valuable for the determination of the crimp result. It has shown that the crimping process can be assessed sufficiently reliable in case the at least one time-based signal is configured as at least one time-based force signal.

In an advantageous embodiment, the force sensor, e.g. a load cell, is arranged at the crimping tool, especially between the crimp press and the crimping tool front end. The force sensor may also be arranged at a different position suitable to detect a time-based force signal related to the crimping force. It has shown that the use of a time-based force signal shows good results for determining a crimp result based on such time-based force-signal analysed via a respectively trained neural network.

In a further embodiment at least one time-based structure-borne sound signal detected at the crimping tool and/or at the crimp anvil and/or at the crimp anvil support, whereas the at least one time-based signal of structure-borne sound is detected during a relative movement of the crimping tool and the crimp anvil for a defined time period comprising a contact phase of the crimping tool and the crimp element.

It has shown that the crimping process can be assessed sufficiently reliable in case if the at least one time-based signal is configured to be a at least one time-based structure-borne sound signal. Such at least one time-based structure-borne sound signal may be detected at the crimping tool and/or the crimp anvil and/or the crimp anvil support.

The time-based signal of structure-borne sound is preferably detected during a relative movement of the crimping tool and the crimp anvil for a defined time period comprising a contact phase of the crimping tool and the crimp element. This means the time-based signal of structure-borne sound is directly related to the crimping process as the time period in which this signal is detected covers the actual crimping of the crimp element. The temporal course of the structure-borne sound signal is directly related to the interaction of the crimping tool and the crimp anvil as well as to the crimp element/conductor configuration arranged between the crimping tool and the crimp anvil.

The at least one time-based signal of structure-borne sound can be detected at the group selected from the crimping tool, the crimp anvil, and the crimp anvil support. The crimp anvil support is the support structure supporting the crimp anvil. As the crimp anvil support is also arranged closely to the actual deformation process of the crimp element, the crimp anvil support is also suitable for arranging at least one sensor configured to detect a time-based structure-borne sound signal.

At least one respective sensor to detect a time-based structure-borne sound signal can be arranged at the crimping tool, especially at the crimping tool front end, e.g. in the environment of the non-exchangeable part, i.e. preferably not at a crimping die. As alternative or in addition, the respective sensor to detect a time-based structure-borne sound signal can be arranged at the crimp anvil and/or at the crimp anvil support.

It is advantageous to arrange a respective sensor to detect a time-based structure-borne sound signal as close as possible to the spatial area, in which the actual crimping of the crimp element takes place. This provides a low degree of relay of the signal; further the signal is only influenced negligibly from other sources than the actual crimping process, and the amplitudes of the detected signal associated with the crimping process are comparably high.

The accuracy can be improved, in case the crimping tool front end and the crimp anvil, or instead of the crimp anvil the crimp anvil support, comprise both at least one respective sensor to detect a time-based structure-borne sound signal. It is further advantageous, if such at least one first and at least one second sensor are configured to detect a structure-borne sound signal in differing frequency ranges, e.g. for a high frequency range and for a low frequency range of structure-borne sound signals. This further improves the accuracy of the determined crimp result, as additional information on the crimping process is provided by monitoring differing frequency ranges.

In a preferred embodiment a combination of two types of time-based signals, which is at least one time-based structure-borne sound signal and at least one time-based force signal, are used for the classification of the crimp result by the respectively trained neural network.

By utilizing such combination of at least one time-based structure-borne sound signal and at least one time-based force signal, the accuracy of the classification result can be significantly increased. For this specific configuration, the trained neural network is trained accordingly at least on the basis of the combination of these two types of time-based signals.

In a further embodiment the at least one time-based signal comprises a time-based position signal for the crimping tool relative to the crimp anvil, whereas the at least one time-based position signal is detected for a defined time period comprising a contact phase of the crimping tool and the crimp element. Such temporal course of the position signal of the crimping tool, especially of the crimping tool front end, relative to the crimp anvil provides further information on the crimping process. A relative position of the crimping tool to the crimp anvil shall be understood broadly. In a known spatial configuration of the position of the crimping tool and the crimp anvil no position difference needs to be given. It is sufficient to measure an absolute position of the crimping tool if the absolute position of the crimp anvil is known in the same reference system.

Such time-based position signal of the crimping tool relative to the crimp anvil may be determined directly or indirectly. A direct way would be a position sensor that determines the position of a reference point of the crimping tool, especially the crimping tool front end, relative to a known and spatially fix reference point. E.g. a distance sensor can be used that measures the distance of the crimping tool to a fix reference point, e.g. arranged at a support frame for the crimping tool supporting the crimping tool.

Also an indirect way of measuring the position of the crimping tool to the crimp anvil may implemented e.g. by measuring parameters of the motor moving the crimping tool. E.g. angles, motor positions and/or the motor load of the crimp press can be used to determine the position of the crimping tool relative to the crimp anvil. Also, other parameters may be utilized for an indirect determination of the position of the crimping tool to the crimp anvil.

In case the time-based position signal is utilized in combination with the time-based force signal and/or time-based structure-borne sound signal and/or in combination with at least one of the other types of time-based signals the accuracy of the classification result based on such combination of different types of time-based signals is improved.

Especially the detection period, i.e. the time-period over a which a time-based signal, especially the at least one structure-borne sound signal and/or the at least one time-based force signal, is captured or detected by a respective sensor, can be controlled on basis of the time-based position signal. This allows to focus the detection period on a time-period of the crimping process relevant to characterize the crimping result. In such case the trained neural network is trained to determine a classification and the respective result based on such combination of different types of time-based signals, which may also include the time-based position signal.

In a further embodiment the at least one time-based signal comprises a time-based acceleration signal detected at the crimping tool and/or the crimp anvil, whereas the at least one time-based acceleration signal is detected for a defined time-period comprising a contact phase of the crimping tool and the crimp element. It is understood that a structure-borne sound signal is a specific embodiment of an acceleration signal. However, also other time-based acceleration signals that are no time-based structure-borne sound signals, can be used to further improve the monitoring of the crimp process. Such acceleration signals may be related e.g. to vibrations of the crimping tool, e.g. originating from the motor-driven movement, or may be associated with a gear, which may influence the crimping process.

The consideration of such time-based accelerations signal, especially a time-based accelerations signal, which is not a time-based structure-borne sound signal, by the trained neural network may further improve the accuracy of the classification result.

Such time-based acceleration signal may be used in combination with the time-based force signal and/or the time-based structure-borne sound signal alone and/or in combination with one of the other types of time-based signals described above.

In a further embodiment the at least one time-based signal comprises at least one time-based elongation signal detected at a support frame supporting the crimping tool, whereas the at least one time-based elongation signal is detected for a defined time-period comprising a contact phase of the crimping tool and the crimp element. The elongation as well as a compression, which is a negative elongation, of the support frame to which the crimping tool is mounted, may have influence on the crimping result as well. By applying the respective crimping forces to the crimp element, the support frame may change its physical configuration leading to varying crimp results. It is therefore advantages to provide at least one sensor at the support frame to detect a time-based elongation signal of the support frame during the crimping process.

It may be advantageous to detect a plurality of time-based elongation signals, whereas each time-based elongation signal of the plurality of time-based elongation signals is detected at a different position at the support frame. This allows to better consider the influence of the support frame to the crimping process, especially to the crimp results, as the support frame may react differently for different crimping process configurations.

Considering such at least one time-based elongation signal for the classification by the respectively trained neural network further improves the accuracy of the classification result.

Such at least one time-based elongation signal of the support frame may be used in conjunction with a time-based structure-borne sound signal and/or a time-based force signal alone and/or in combination with at least one of the other types of time-based signals specified above, e.g. the at least one time-based position signal and/or the at least one time-based accelerations signal. Dependent on the specific use of the combinations the neural network is trained correspondingly to determine a classification and a classification result on provided time-based signals.

In another embodiment at least one temperature signal is detected during the crimping process, especially for a defined time-period comprising a contact phase of the crimping tool and the crimp element, and provided to the trained neural network. In embodiments, the at least one temperature signal is an ambient temperature signal. The trained neural network is configured to consider the at least one (ambient) temperature signal for classifying a result of a crimping process based on the received at least one time-based signal and the at least one (ambient) temperature signal.

The temperature, e.g. the ambient temperature, respectively room temperature, given during the crimping process may have an influence on the crimp result as the properties of the used materials, e.g. the crimp element, may have temperature-dependent properties. The ambient temperature is a temperature providing information on the actual ambient temperature while a crimp element is crimped. Such ambient temperature may be detected in the vicinity of the crimp device or on the crimp device, e.g. at a support frame, at the crimping tool, at the crimp anvil, etc.

Experiments have shown that the crimp result seem to have-surprisingly-a significant dependence on the ambient temperature, i.e. the crimp result of a crimping process at 15° C. may highly differ from a crimp result of a crimping result with the same parameters at 25° C. More precisely, it has been found that the model parameters are sensitive to changes of 0.1° C. in ambient temperature, i. e. the model parameters may become different if the ambient temperature decreases or increases by 0.1° C.

Further, it may be of advantage, if the ambient temperature is detected such, that the measurement of the ambient temperature is not influenced by the temperature change of the crimp element during the crimping process, i.e. during its mechanical deformation causing a temperature change of the crimp element during the crimping process.

It is therefore of advantage to take the ambient temperature during the crimping process into account and base the classification of the respectively trained neural network also on the ambient temperature, especially besides other parameter, e.g. like the time-based force signal and/or a time-based structure borne sound signal. Especially, due to a slow temperature change or temperature drift of the ambient temperature over a plurality of cycles of crimping processes the crimping result may be affected by the temperature change, although the other parameters may be maintained.

Temperature changes in ambient temperature during a single crimping process have shown to be less relevant; this is related to the fact that the time period of a single crimping process, especially of the contact phase of the crimping tool and the crimp element, is comparably short to the time scales of thermodynamic processes in the environment affecting an ambient temperature change. I.e. during a single crimping process the ambient temperature is typically constant.

Further, it should be noted that a temperature change of the crimp element itself caused by its deformation is not subject of the proposed temperature detection. Such temperature change of the crimp element during the crimping process may or may not be considered in addition to the detected ambient temperature signal during the crimping process.

Temperature changes in the ambient temperature over a plurality of crimping processes for different crimp elements have shown to be a relevant parameter for the crimping process of a single crimp element. In other words, a change of the ambient temperature for different crimp elements, especially for subsequently processed crimp elements, is of significant relevance. In a specific embodiment the at least one time-based signal comprises an ambient temperature signal, i.e. the temperature signal is configured to be a time-based temperature signal, detected during the crimping process, especially for a defined time-period comprising a contact phase of the crimping tool and the crimp element. In this case a temporal course of an ambient temperature signal detect during the crimping process is provided to the trained neural network. In another embodiment only one ambient temperature detected during the crimping process is provided to the trained neural network and used for determining the classification result.

Also, such ambient temperature signal, especially time-based ambient temperature signal, may be used with the time-based force signal and/or time-based structure-borne sound signal alone and/or in combination with at least one of the other types of time-based signals specified above, e.g. the at least one time-based position signal, the at least one elongation signal and/or the at least one time-based acceleration signal. Dependent on the specific use of the combinations the neural network is trained correspondingly to determine a classification and a classification result on the provided data basis.

In a further embodiment the detection of at least one time-based signal is triggered by a triggering signal detected by a trigger sensor, especially whereas the trigger signal is generated dependent on a predefined position of the crimping tool relative to the crimp anvil. The trigger signal can be applied to any type of the detected time-based signals. The trigger signal may define a measurement window for the detection of time-based signals. Especially a starting point can be provided by the trigger signal, as well as an endpoint. Alternatively, a specified period of time for the detection of a time-based signal can be used.

The use of such trigger signal provides a focus on the relevant data for the crimping process and therefore avoids the capture of data not valuable for the classification of a crimp result. E.g. such measurement window for at least one of the types of time-based signals is started shortly before the contact phase of the crimping tool with the crimp element and stopped short after the crimping tool has been removed from the crimping tool. In total such measurement window may be between 10 ms and 500 ms.

In an advantageous embodiment all utilized time-based signals, especially also the time-based ambient temperature signal, have the same measurement window initialized by the triggering signal. Especially the position signal of the crimping tool can be utilized as triggering signal for the group of time-based signals selected from the time-based structure-borne sound signal, the time-based force signal, the time-based position signal, the time-based acceleration signal, the time-based elongation signal, a time-based ambient temperature signal. E.g. the detection period for all time-based signals referenced before can be started as soon as the position signal reaches a trigger position initiating a measurement cycle for all relevant sensors.

In a further embodiment the control signal is provided with a repetition rate of 2 seconds or less, especially of one second to 0.5 seconds. With such repetition rate a real-time monitoring of the crimp result can be provided based on such control signals as well as a real-time control of the crimp device based on such control signal.

In an embodiment the classification result further comprises a crimp quality indicator, e.g. the crimp height or the crimp width, related to the quality of a crimped connection of the crimp element and the conductor, especially in case the crimp connection is classified as non-defective.

The crimp quality indicator gives a more specific information to the crimp result, especially for every manufactured and monitored crimped connections. Especially in case the crimped connection is classified as defective the crimp quality indicator can be used to determine if the crimped connection can be corrected or not. In case the crimped connection is non-defective, the crimp quality indicator can be monitored for non-defective crimp results and information is provided on mean values and the root mean square deviation can be determined for non-defective crimp results. Such crimp quality indicator may be displayed on a monitor or may be used as input for a control unit of the crimp device.

Such crimp quality indicator, e.g. the crimp height and/or the crimp width, allows especially to continuously monitor the output of the crimping process for every crimped connection.

Conventionally, the quality of a crimped connection is checked only by taking random or regular samples from the manufacturing process. E.g. for every 100 or 1000 manufactured crimped connections one crimped connection is analysed conventionally, i.e. outside of the manufacturing process, for checking the crimp quality, e.g. crimp height and/or crimp width, generated by the crimping process. During the analysis of the crimped connection, typically supported by a test facility, the manufacturing process for other crimped connections continues. In case the crimp quality is not sufficiently high for the test sample, further crimped connections not satisfying the desired quality standard are manufactured while the analysis of the test sample takes place. This is disadvantageous for the manufacturing efficiency. Further, it is impossible by the conventional approach to monitor the crimp quality indicator for each and every crimped connection without significant disadvantages regarding the manufacturing process, especially regarding throughput.

Therefore, in a further embodiment, the crimp quality indicator is determined for a plurality of subsequently manufactured crimped connections, whereas between each crimped connection from the plurality of subsequently manufactured crimped connections less than 100, especially less than 50, especially less than 10, especially less than 1, crimped connections are manufactured for which no crimp quality indicator is determined. The limitation less than 1 equals to the fact that for every crimped connection of the plurality of crimped connections a crimp quality indicator is determined.

By utilizing an embodiment of the presented method to determine as classification result for a crimp quality indicator based on at least one time-based signal related to the crimping process, the throughput of the manufacturing line is not affected although the crimp quality can be determined for every crimped connection.

By providing a respectively trained neural network utilizing at least one time-based signal, a crimp quality indicator can be provided e.g. for each crimped connection providing much more close monitoring on manufactured crimp connections and the crimping process. This enables a real-time control of the manufacturing process for crimped connections.

In a further embodiment, the crimp quality indicator is detected over time, i.e. a temporal course of the crimp quality indicator is captured, and analysed, whereas based on such analysis a crimp quality control signal, especially in case the quality control indicator decreases below a defined minimum quality indicator threshold, is generated on which the operation of the crimp device is controlled such by means of the quality control signal that the crimp quality indicator increases for a crimped connection to be crimped by the crimp device. Such minimum quality indicator threshold can be determined such that the respective a classification result for a crimp result having such minimum quality indicator threshold is not determined to be “defective”. This allows to influence the crimping process before a crimp result is determined to be defective.

Influencing a crimping process on basis of such crimp quality control signal assures that the crimp quality indicator remains comparably constant within a desired range providing high quality crimped connections.

The control signal generated on basis of the classification result may comprise such crimp quality control signal.

In a further embodiment the classification result further comprises a failure indicator allowing the identification of a certain defect from a plurality of defects identifiable by the trained neural network for the crimped connection of the crimp element and the conductor in case the crimped connection is classified as defective. Such failure indicator may relate to the crimping process or to the crimped connection itself. Especially, such failure indicator provides information on the kind of defect as classified by the trained neural network, especially of the crimped connection. Such crimp failure indicator can be descriptive for a user and/or can be the basis of a specific control signal dependent on the failure indicator. Such failure indicator provides the possibility to control the crimp device individually based on the detected failure. Therefore, a control signal corresponding to the failure indicator may be used as input for a control unit of the crimp device. Such failure indicator may also be displayed on a monitor to be perceivable by respective personal.

In a further embodiment the classification result further comprises a data anomaly indicator in case no identification of a certain defect from a plurality of defects identifiable by the trained neural network for the crimped connection of the crimp element and the conductor can be determined in case the crimp connection is classified as defective. Such data anomaly indicator allows to capture crimp results classified as defective, whereas the defect cannot be identified. Such anomaly indicator allows to collect data on defects that are not yet part of the training data of the neural network. Especially, such kind of defects may be monitored or investigated manually by respective personal.

In a further embodiment plurality of identified anomalies and/or a plurality of identified data anomaly indicators are clustered in clusters of anomalies. Such clusters of anomalies can be used to further train the trained neural network for a new type of defect associated with the identified anomalies and/or the identified anomaly indicators. Especially, such training can be provided if the number of anomalies within a certain cluster exceeds a certain threshold, meaning that a certain defect is detected sufficiently often to justify and/or enable a re-training of the neural network on such anomaly, respectively on that new kind of defect.

In a further embodiment the crimp device is controlled based on the control signal in such way that the crimping process, especially at least one control parameter to influence the operation of the crimp device, is changed such that a non-defective crimp connection comprising a crimp element and a conductor to be processed is created. Such at least one parameter of the crimping process is a parameter influencing the crimping process and its result. Typically, such at least one parameter is at least one actuating parameter of the crimp device, e.g. the crimping force applied by the crimping tool, the motor speed, motor torque, speed and/or acceleration of the crimping tool, spatial adjustments, etc.

Using the control signal in such way allows a control, especially a closed-loop real-time control, of the crimp device. This can be used to achieve a stable operation of the crimp device and a stable production of crimp connections with such crimp device.

The present invention relates further to a machine readable program code comprising control commands, which initiate in case of their execution the execution of a method according to one of the method claims. Such machine readable program code can be accessed via a remote storage or a local storage, e.g. comprised by a control unit of the crimp device.

Another embodiment of machine readable program code may comprise control commands, which are configured to provide a detected time-based signal to a trained neural network, whereas the trained neural network is configured to classify a result of a crimping process based on the received at least one time-based signal, whereas the classification result comprises at least a class of a non-defective and a class of a defective crimp result, and to provide a corresponding classification result, whereas a control signal is generated and provided as output based on the determined classification result. This machine-readable program code can be provided locally or may be accessed on a remote server, e.g. accessible via an interface to a cloud infrastructure.

The invention further relates to a control unit comprising machine readable program code, whereas the program code comprises control commands, which initiate in case of their execution the execution of a method according one of the method claims.

The invention may further relate to a control unit comprising machine readable program code, whereas the machine readable program code comprises control commands configured to provide a detected time-based signal, e.g. at least one time-based force signal and/or at least one structure-borne sound signal, to a trained neural network, whereas the trained neural network is configured to classify a result of a crimping process based on the received at least one time-based signal, whereas the classification result comprises at least a class of a non-defective and class of a defective crimp result, and whereas the trained neural network is configured to provide a corresponding classification result and to provide a control signal as output based on the determined classification result, whereas the control unit is configured to receive such control signal from the trained neural network. The trained neural network can be configured to provide as classification result the respective indicators, especially a crimp quality indicator, a failure indicator, etc., as described above.

The trained neural network can be utilized via a cloud infrastructure. In this case the control unit provides the time-based signal to and only an input signal is provided based on the detected time-based signal, e.g. a time-based force signal and/or time-based structure-borne sound signal, to an interface to provide it to the neural network. The neural network then provides back the respective control signal via the interface to and can use this control signal e.g. controlling the crimp device or displaying the classification result. However, the trained neural network may also be provided locally, especially in a storage of the control unit.

The invention further relates to a crimp device comprising a crimping tool and a crimp anvil, further comprising at least one sensor to detect at least one time-based signal during a crimping process, further comprising a control unit according to claim 15 and whereas the at least one sensor is connected to the control device. The crimp device may especially comprise at least one sensor of the group of sensors: sensor for detecting a structure-borne sound signal, sensor for detecting a time-based force signal, sensor for detecting a time-based position signal of the crimping tool relative to the crimp anvil, sensor for detecting a time-based acceleration signal, sensor for detecting a time-based elongation signal, sensor for detecting a time-based ambient temperature signal, sensor for triggering a sensor for detecting a time-based signal. The presence of the specific sensor types comprised by the crimp device shall correspond to the types of time-based signals used for the analysis of the crimp process by the trained neural network.

### BRIEF DESCRIPTION OF THE DRAWINGS

For a more complete understanding of the present disclosure and advantages thereof, reference is now made to the following description taken in conjunction with the accompanying drawings. The disclosure is explained in more detail below using exemplary embodiments which are specified in the schematic figures of the drawings, in which:

FIG. 1 a schematic illustration of a crimp device according to the invention in a first exemplary configuration,

FIG. 2 a schematic illustration of a crimp device according to the invention in a second exemplary configuration,

FIG. 3 a schematic illustration of a crimp device according to the invention in a third exemplary configuration,

FIG. 4 an aggregation of time-based signals usable by the trained neural network to determine a classification result,

FIG. 5 a flowchart showing a flow of method steps according to an exemplary embodiment of the method.

In the figures like reference signs denote like elements unless stated otherwise.

### DETAILED DESCRIPTION OF THE DRAWINGS

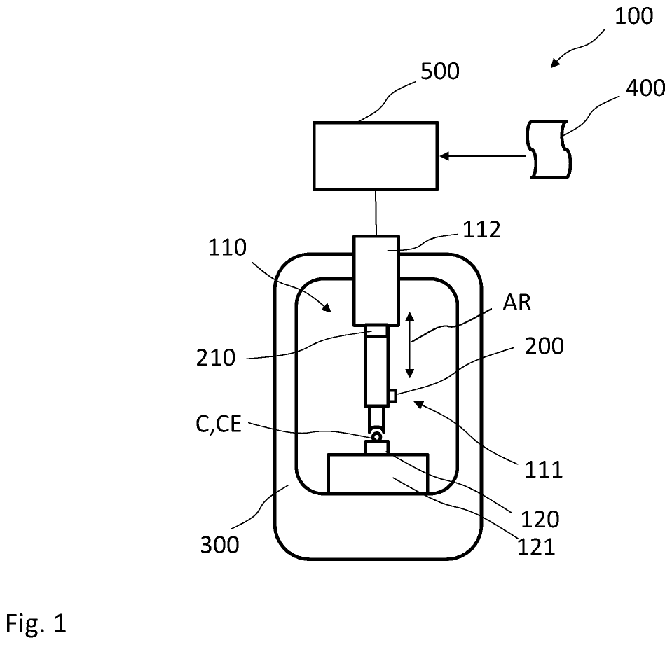

FIG. 1 shows a first embodiment of a crimp device 100, which is enabled to implement an embodiment of the invention, especially to classify a crimp result based on a time-based signal captured during the crimping process.

The crimp device 100 comprises a crimping tool 110 and a crimp anvil 120. The crimping tool 110 further comprises a crimping tool front end 111 and a crimp press 112. The crimping tool 110, or at least a part of the crimping tool front end 111, is movable relative the crimp anvil 120, typically with a motor, not shown.

To crimp a contact C to a crimp element CE the crimping tool front end 111 is pressed on the crimp anvil while the overlapping part of the contact C and the crimp element CE are arranged between the crimping tool front end 111 and the crimp anvil 112.

By applying sufficiently high pressure to the contact C and the crimp element CE, these components C and CE are attached to each other by cold forging. The crimping tool front end 111 may have exchangeable tool attachments, also called dies, to be adapted for the processing of different crimp process configuration, e.g. due to different diameters, different materials, different crimp configurations, etc.

The relative movability of the crimping tool 110 relative to the crimp anvil via a motor of the crimp press is shown in FIGS. 1 to 3 by a respective arrow AR.

According to FIG. 1 the crimping tool 111 and the crimp anvil 120 are supported at a support frame 300. It is not necessary that the crimping tool 111 and the crimp anvil 120 are supported at the same frame 300. However, as the crimping process is sensitive to the lateral relative position, i.e. in the direction in the sheet level perpendicular to the shown arrow, of the crimping tool front end 111 and the crimp anvil 120, supporting and adjusting the crimping tool 110 and the crimp anvil 120 at the same support frame 300 may have advantages.

Further, the crimp device 100 of FIG. 1 comprises several sensor types. According to FIG. 1 two sensors are provided to capture a time-based signal of the crimping process.

As a first sensor the crimp device 100 comprises a sensor 200 configured detect a time-based structure-borne sound signal. This sensor 200 configured to detect a time-based structure-borne sound signal is attached to the crimping tool front end 111, especially within the last third of the crimping tool front end 111. This allows a good capture of the structure-borne sound generated by the crimping process, especially during the contact phase of crimping tool front end 111 with the crimp element CE, especially in the deformation phase of the crimp element CE, via the sensor 200.

In addition or as alternative, such sensor configured to detect a time-based structure-borne sound signal may be arranged at the crimp anvil 120. Such arrangement at the crimp anvil 120 or in its vicinity, e.g. at the crimp anvil support, also provides a low spatial distance to the actual crimping process of the crimp element CE and allows a good capture of a time-based structure-borne sound signal related to the crimping process.

It shall be noted that at least two sensors configured to detect a time-based structure-borne sound signal can be present, where each of these sensors detects a different frequency spectrum. This can be an overlapping frequency range or may be not-overlapping frequency ranges, i.e. distinct frequency ranges. The at least two sensors may be arranged at different positions at the crimp device 100, especially at different components of the crimp device 100, e.g. the crimping tool 110, especially the crimping tool front end 111, the crimp anvil 120 and/or the crimp anvil support 121.

E.g. a first sensor configured to detect a time-based structure-borne sound signal may be configured to detect only frequencies above a certain threshold frequency, whereas a second sensor configured to detect a time-based structure-borne sound signal may be configured to detect only frequencies below a certain threshold frequency. Different frequency ranges may provide additional information in terms of the course of the crimping process and therefore can be advantageous for determining a crimp result based on such signals relating to different frequency bands.

The crimp anvil 120 provides a counter pressure to the force applied by the crimping tool 111 to realize a deformation of the crimp element CE, when force is applied on the crimp element CE positioned on the crimp anvil 120, and therefore a secure connection of the crimp element CE with the conductor C is created.

As a second sensor the crimp device 100 comprises a sensor 210 configured to detect a time-based force signal. The time-based force signal shall advantageously be related as close as possible to the crimping force. The sensor 210 configured to detect a time-based force signal may be realized as load cell, especially piezo load cell. The sensor 210 configured to detect a time-based force signal is arranged such that a time-based force signal can be detected that is related to the temporal course of the crimping force applied to the crimp element CE.

Especially, such sensor 210 configured to detect a time-based force signal is arranged between the crimping tool front end 111 and the crimp press 112 generating the crimp force. Preferably, the time-based force signal related to the crimping force is the time-based crimping force signal itself. Such force sensor 210 might also be arranged, in addition or as alternative, at the crimp anvil 120.

During the crimping process both time-based signals of the respective sensors 200 and 210 are detected. Both time-based signals are captured during a time window comprising at least the contact phase of the crimping tool 110 and the crimp element CE.

The contact phase starts when the crimping tool front end 111 gets in contact with the crimp element CE, further comprises the period of deformation of the crimp element CE and ends, when the crimper tool front end 111 is no longer in contact with the crimped crimp element CE.

The sensor 200 configured to detect a structure-borne sound signal and the sensor 210 configured detect a time-based force signal are each connected to a control unit 500. The detected time-based signals are respectively provided to the control unit 500.

The control unit 500 is configured to analyse the crimping process based on the provided time-based signals captured during the crimping process. For this purpose, the control unit 500 comprises machine readable program code 400 to receive and/or retrieve the time-based signals from the connected sensors.

Further the control unit 500 is enabled by the machine readable program code 400 to process the time-based signals from the respective sensors and to analyse these by providing the time-based signals to a trained neural network. The trained neural network is configured to classify a crimp result based on the time-based signals fed to the trained neural network and is implemented correspondingly via the machine readable program code 400.

Accordingly, a control signal is provided based on a determined crimp result when the control commands comprised by the machine readable program code 400 are executed. Such control signal can be used to control the crimp device and/or to provide an illustration of the crimp result on a control display for respective personal.

The control signal may load the machine readable program code 400 in a local storage, e.g. comprised by the control unit 500, or may provide the time-based signal to a cloud infrastructure via a respective interface, whereas the analysis may then be executed in the cloud. A classification result and/or a respective control signal may be provided via an interface of the control unit 500 from the cloud.

However, as high reliability regarding the availability of the classification result and the respective control signal as well as real-time monitoring capability is of importance, a local set-up for accessing the machine readable program code 400 might be preferable.

According to FIG. 1 the crimping process is analysed on basis of the time-based structure-borne sound signal and the time-based force signal captured during the crimping process. Both signals are captured during at time window comprising at least the contact phase of the crimping tool 110 and the crimp element CE.

It has shown that the combination of the temporal course of the structure-borne sound signal and of the temporal course of the force signal provide very accurate classification result and high reliability regarding the crimp result achieved by the crimping process to which the respective signals are detected.

The detection period, i.e. a defined time period in which a respective time-based signal is detected, comprises preferably the entire contact phase of the crimping tool and the crimp element. The single values detected in the defined time period shall be detected with a timely distance from each other that allows a reliable monitoring of the crimping process. Preferably, the detection period for the two sensors 200 and 210 according to FIG. 1 is configured as time window of 300 ms to 500 ms, whereas subsequent measurement values of the respective sensors 200, 210 are detected with a sampling rate of 1 ms or less.

The detection of the time-based structure-borne sound signal and the time-based force signal is constantly repeated such that it captures subsequently the consecutive single crimping processes for the crimp elements over time. The control signal based on these captured time-based signals is generated with repetition rate of less than 1 s to allow a real-time control of the crimping process, respectively the crimp device 100.

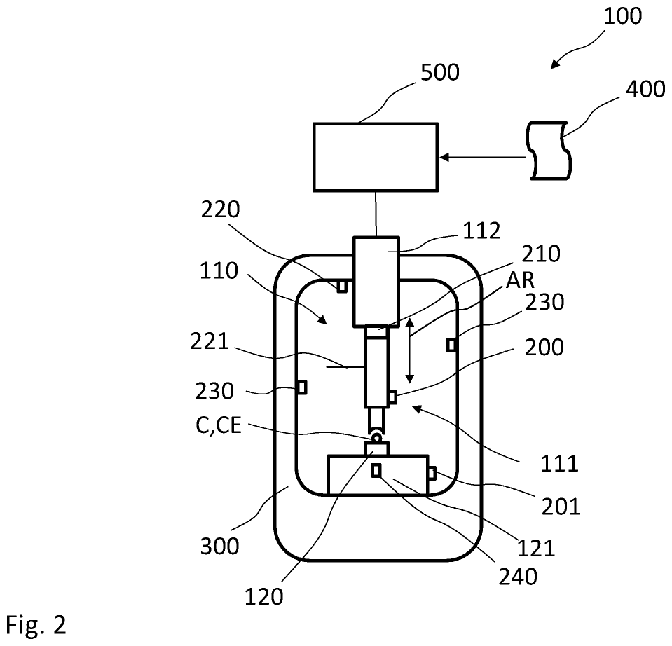

FIG. 2 shows another embodiment of a crimp device 100 enabled to execute an embodiment of the method according to the invention. The crimp device 100 is comparably similar to the crimp device 100 according to FIG. 1. However, the crimp device 100 according to FIG. 2 further comprises additional types of sensors configured to detect additional types of time-based signals.

E.g. the crimp device 100 further comprises two sensors 230 configured to detect a time-based elongation signal, also denoted as elongation sensor in the following, of the support frame 300 during the crimping process. The elongation sensor 230 detect a temporal course of an elongation signal of the support frame 300, especially during the time when the crimping tool front end 111 contacts the crimp element CE. A deformation, also only a slight deformation, of the support frame 300 during the crimping process can influence the result of the crimping process. For this reason, including such time-based signal into the analysis of the control unit is advantageous. The two sensors 230 configured to detect a time-based elongation signal are located at different positions at the support frame 300.

Further the crimp device 100 according to FIG. 2 comprises a first sensor 200 configured to detect a time-based structure-borne sound signal and a second sensor 201 to detect a time-based structure-borne sound signal. The first sensor 200 is arranged at the crimping tool front end 111. The second sensor 201 is arranged in the vicinity, especially at the crimp anvil support 121, of the crimp anvil 120. It may also be arranged at the crimp anvil 120 itself.

In this configuration two independent time-based signals providing structure-borne sound signals are available to be provided to the control unit 500, which can improve the accuracy of the classification result, as additional information on the crimping process from distinct parts of the crimp device 100 can be utilized. Further the first and second sensor 200, 201 are configured to the detect structure-borne sound in different frequency ranges.

Instead of the first or second sensor 200, 201 a sensor configured to detect a time-based acceleration signal, which is not a structure-borne sound signal, may be provided at the crimping tool 111 or at the vicinity of the crimp anvil 120, especially at the crimp anvil support 121, or at the crimp anvil 120.

Further a sensor 220 configured to detect the relative position of the crimping tool 110 relative to the crimp anvil 120 is provided, which is denoted also as position sensor 220 in the following. The position sensor 220 can be implemented as distance measuring sensor.

Such sensor 220 can be arranged at the support frame 300. In terms of position measurement the support frame 300 has a constant spatial position, whereas the crimping tool 110, especially the crimping tool front end 111, moves relatively to that support frame 300. For that reason, it is suitable to arrange a position sensor 220 configured as distance measuring sensor at the support frame 300.

Such sensor 220 can work optically or otherwise and determine the distance of a position reference element 221 arranged at the crimping tool 110, especially at the crimping tool front end 111. As sensor configured to detect a relative position of the crimping tool 11 to the crimp anvil 120, also a motor parameter, e.g. its power load, angle, or other parameter, of the crimping tool 111, especially of the crimp press 112, can be used.

The relative position of the crimping tool 111 relative to the crimp anvil 120 can advantageously be used as trigger to start a detection period of the other types of sensors, e.g. the first and second sensor 200 and 201 configured the detect a time-based structure-borne sound signal, the sensor 210 configured to detect a time-based force signal, and other sensors for detecting a time-based signal related to the crimping process. This can also apply to a temperature sensor 240, which is also present in the crimp device 100 according to FIG. 2 and detects a time-based ambient temperature signal. Such triggering of a detection period for several types of sensors 200, 201, 210, 230, 240 can be controlled by the control unit 500.

All sensors 200, 201, 210, 220, 230, 240 configured to detect time-based signals related to the crimping process are connected to the control unit and the respective time-based signals are provided to the control unit 500.

The trained network, to which the time-based signals are provided for classification purposes is trained to determine a classification result based on all time-based signals provided to the trained neural network. Such broad basis of time-based signal related to the crimping process increases the accuracy of the determined crimp result determined by the neural network.

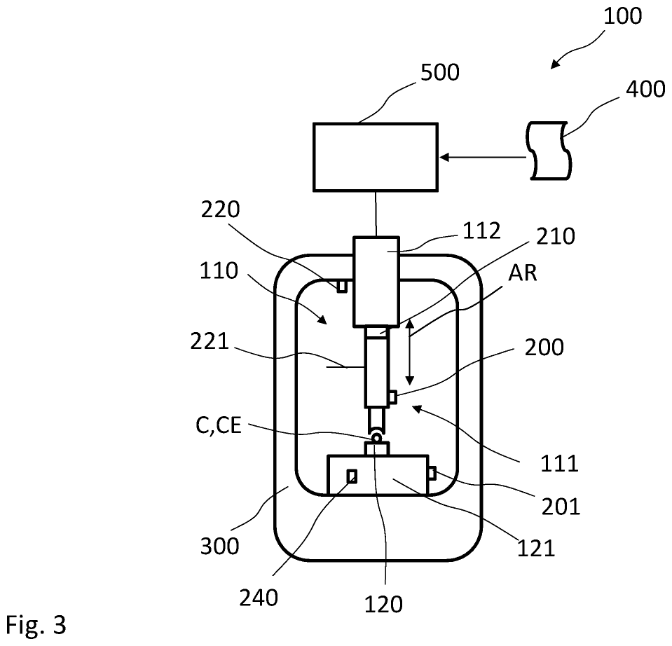

FIG. 3 shows another embodiment of the crimp device 100 suitable to determine crimp results on time-based signals captured via different sensors 200, 201, 210, 220, 240.

The crimp device 100 according to FIG. 3 comprises a first and a second sensor 200, 201, each configured to detect a time-based structure-borne sound signal during the crimping process. The first sensor 200 and the second sensor 201 are configured to detect time-based structure-borne sound signals, whereas the first sensor 200 detects time-based structure-borne sound signals of a first frequency range and the second sensor 201 detects time-based structure-borne sound signals of a second frequency range. This allows e.g. to monitor a high frequency band for a time-based structure-borne sound signal and at the same time a low frequency band for a time-based structure-borne sound signal during the crimping phase, especially during a contact phase of the crimping tool 111 with the crimp element CE. Such configuration provides additional information on the crimping process.

Further the crimp device 100 according to FIG. 3 comprises a sensor 210 configured to detect a time-based force signal related to the crimping force, a temperature sensor 240 configured to detect a time-based ambient temperature signal and a sensor 220 configured to detect a time-based position signal of the crimping tool 111 comprising a position reference element 221.

It has been shown that such configuration of plurality of sensors is especially advantageous to determine an accurate classification result during the crimp manufacturing process.

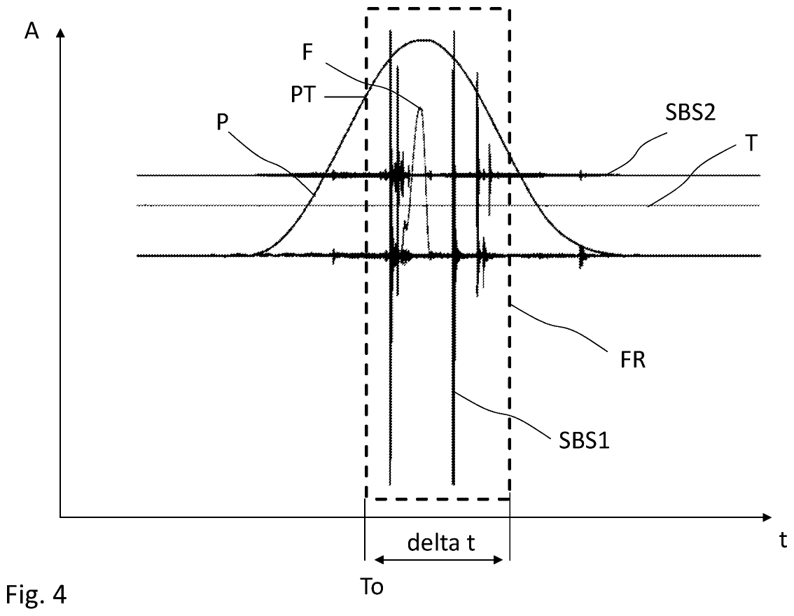

FIG. 4 shows a plurality of time-based signals, which can be acquired with a sensor configuration of FIG. 3. Two temporal courses of structure-borne sound signals are shown in FIG. 4 over time. A temporal course of the first structure-borne-sound signal is denoted as SBS1, whereas a temporal course of the second structure-borne-sound signal is denoted as SBS2. SBS1 shows a temporal course of high frequency structure-borne sound, whereas SBS2 shows a temporal course of low frequency structure-borne sound. A further type of time-based signal is provided, which is configured as temporal course of a force signal F. Another type of time-based signal is provided, which is configured as temporal course of a position signal P of the crimping tool. A further type of time-based signal is shown, being a temporal course of the ambient temperature signal T. The signals have an amplitude A which is applied on the y-axis, whereas the time t is applied on the x-axis.

In FIG. 4 further a frame FR is shown. The frame FR shows exemplarily the relevant time period suitable to determine a classification result based on time-based signals contained in this frame FR by providing these to the respectively trained neural network.

Further, it becomes visible from FIG. 4 that reaching a certain position PT of the crimping tool can be used to define a starting time T to start a detection period delta t for several types of sensors, i.e. to start a detection period delta t for each crimping process for all utilized sensors. The position signal P is especially suitable to provide such trigger function. It is understood that such trigger function is independent of the types of sensors to be triggered, i.e. all combinations of different types and numbers for sensors or single sensors can be triggered via such trigger function to start and/or end the detection period, respectively the measurement window.

The detection period delta t can end, when a predefined position of the crimping tool is reached, e.g. when the trigger position PT is reached again after the crimping process, i.e. when the crimping tool is moved back from the crimp anvil. The detection period delta t may also be configured to have a fixed period, especially a fixed period for all time-based signals. The detection period delta t for some or all the different time-based signals can also be different and does not need to be necessarily the same.

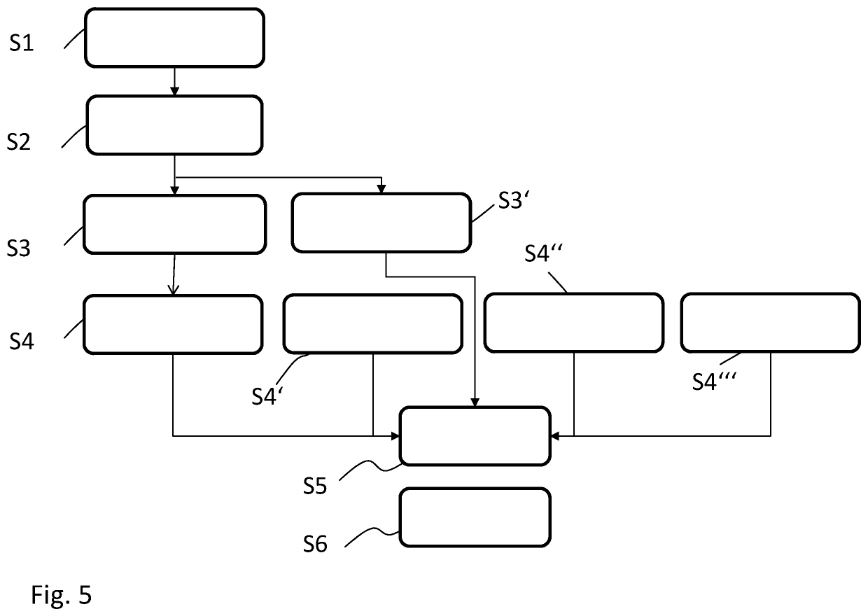

FIG. 5 shows a schematic flow diagram illustrating an exemplary embodiment of a method according to the invention.

In a first step S0 a plurality of time-based signals is detected and provided to the control unit. Based on FIG. 4 such time-based signals can be a first and a second structure-borne sound signal whereas the corresponding sensors focus on different frequency ranges. Further a time-based force signal may be detected and provided to the control unit.

In second step S1 the received data is checked by the control unit in terms of thresholds relating to the provided sensor signals and other machine data. This check is supposed to identify machine and sensor failures which do not allow a reasonable analysis. This step can be provided in a conventional way or via the respectively trained neural network.

In a third step S2 a further check of the provided is made regarding the presence of a severe respectively heavy anomaly in the crimping process. Such heavy anomaly detection is implemented via a respective machine learning algorithm which is part of the trained neural network. In case a heavy anomaly is determined a respective failure indicator is provided and the process is stopped. Such heavy anomaly detection can e.g. be implemented via a one-class support vector machine.

In case no heavy failure anomaly is determined, a further check is made in a step S3 regarding the presence of light anomalies. Light anomalies are known anomalies in the crimping process which concern the crimp result comprising typical error patterns or failure patterns. Such light anomaly detection can be implemented by a respective machine learning algorithm, e.g., a support vector machine. In parallel the presence of a conductor can be determined by the trained neural network based on the provided data in a step S3′.

Subsequently, a several classification tasks may be performed in parallel by the respectively trained neural network. These can also be performed subsequently. However, due to the real-time control capability of the method a parallel process might be preferred.

E.g. in a step S4 the crimp height adjustment of the crimping tool can be determined by the respectively trained neural network. In parallel, in a step S4′, the crimp height of the crimped crimp element can be determined via the respectively trained neural network. In addition, the respectively trained neural network also determines the completeness of strands for the crimping process in step S4″, i.e. it is checked if all strands are inserted in the crimp element. Further, in a step S4″ the position of the conductor is determined by the respectively trained neural network.

In a step S5 the classification result is determined, which at least comprises a class for a defective crimp result and or class for a non-defective crimp result. Further, a vector can be provided with the classification result of the different checks of steps S1 to S4′″. The classification result of being at least a defective crimp result or a non-defective crimp result can be derived via the trained neural network or may derived outside the neural network e.g. by combining the classification results of the previous step S1 to S4′″ according to valuation logic. This valuation logic may then determine based on the provided classification results of the previous steps, if a non-defective or a defective-crimp result is given.

In a step S6 a control signal is provided that can be used for displaying the classification result and/or controlling the crimp device by utilizing the control signal by the control unit, e.g. especially based on a crimp quality control signal associated with determined crimp height.

Although specific embodiments have been illustrated and described herein, it will be appreciated by those of ordinary skill in the art that a variety of alternate and/or equivalent implementations exist. It should be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

### LIST OF REFERENCE SIGNS

100 crimp device
110 crimping tool
111 crimping tool front end
112 crimp press
120 crimp anvil
121 crimp anvil support
200 sensor for detection of a time-based structure-borne sound signal, first
201 sensor for detection of a time-based structure-borne sound signal, second
210 sensor for detection of a time-based force signal
220 sensor for detection of a time-based position signal
221 position reference element of the crimping tool
230 sensor for detection of a time-based elongation signal
240 sensor for detection of a time-based temperature signal
250 sensor for detection of a time-based acceleration signal
300 support frame
400 machine readable program code
500 control unit
SBS1 time-based structure-borne sound signal, first
SBS2 time-based structure-borne sound signal, second
F time-based force signal
P time-based position signal
E time-based elongation signal
T time-based temperature signal
PT Trigger position
To Starting time for detection period
delta t detection period
C conductor
CE crimp element
t time
AR moving direction of the crimping tool relative to the crimp anvil caused by the crimp press
S0 Detection and Provision of a plurality of time-based signals
S1 Examination of thresholds of sensor and machine data
S2 Detection on severe anomalies
S3 Detection of light anomalies
S3′ Detection of presence of conductor
S4 Assessment of crimp height adjustment
S4 Assessment of crimp height
S4″ Assessment of completeness of strands
S4′″ Assessment of position of conductor
S5 Determination of classification result
S6 Provision of classification results as control signal

1. A method for crimping a crimp element to a conductor by a crimp device comprising a crimping tool and a crimp anvil,
wherein at least one time-based signal is detected relating to a crimping process performed by the crimp device,
wherein the at least one time-based signal is analysed by applying the at least one time-based signal to a trained neural network, wherein the trained neural network is configured to classify a result of the crimping process based on the at least one time-based signal,
wherein a classification result comprising at least a class corresponding to a non-defective crimp result and a class corresponding to a defective crimp result is provided by the trained neural network, based on the classification performed by the trained neural network,
wherein a control signal is generated and provided as output based on the classification result.

2. The method according to claim 1, wherein the at least one time-based signal comprises at least one time-based force signal related to a force applied to a crimp element by the crimping tool, wherein the at least one time-based force signal is detected for a defined time period comprising a contact phase of the crimping tool and the crimp element.

3. The method according to claim 2, wherein at least one temperature signal is detected during the crimping process within or for a defined time-period comprising a contact phase of the crimping tool and the crimp element, wherein the temperature signal is an ambient temperature signal and is provided to the trained neural network, wherein the trained neural network is configured to consider the ambient temperature signal for classifying a result of the crimping process based on the at least one time-based signal and the ambient temperature signal.

4. The method according to claim 1, wherein the at least one time-based signal comprises at least one time-based structure-borne sound signal detected at least one of at the crimping tool, at the crimp anvil, or at a crimp anvil support, wherein the at least one time-based signal of structure-borne sound is detected during a relative movement of the crimping tool and the crimp anvil for a defined time period comprising a contact phase of the crimping tool and the crimp element.

5. The method according to claim 1, wherein the at least one time-based signal comprises at least one time-based position signal for the crimping tool relative to the crimp anvil, wherein the at least one time-based position signal is detected for a defined time period comprising a contact phase of the crimping tool and the crimp element.

6. The method according to claim 1, wherein the at least one time-based signal comprises at least one time-based acceleration signal detected at least one of at the crimping tool or at the crimp anvil, wherein the at least one time-based acceleration signal is detected for a defined time-period comprising a contact phase of the crimping tool and the crimp element.

7. The method according to claim 1, wherein the at least one time-based signal comprises at least one time-based elongation signal detected at a support frame supporting the crimping tool, wherein the at least one time-based elongation signal is detected for a defined time-period comprising a contact phase of the crimping tool and the crimp element.

8. The method according to claim 1, wherein the detection of at least one time-based signal is triggered by a triggering signal detected by a trigger sensor, wherein the trigger signal is generated dependent on a predefined position of the crimping tool relative to the crimp anvil.

9. The method according to claim 1, wherein the control signal is provided with a repetition rate of 2 seconds or less.

10. The method according to claim 1, wherein the classification result further comprises a crimp quality indicator which is related to the quality of a crimped connection of the crimp element and the conductor when the crimped connection is classified as non-defective.

11. The method according to claim 1, wherein when a crimped connection of the crimp element and the conductor is classified as defective, the classification result further comprises a failure indicator allowing an identification of a certain defect from a plurality of defects identifiable by the trained neural network for the crimped connection of the crimp element and the conductor.

12. The method according to claim 1, wherein in case a crimped connection of the crimp element and the conductor is classified as defective the classification result further comprises a data anomaly indicator in case no identification of a certain defect from a plurality of defects identifiable by the trained neural network for the crimped connection of the crimp element and the conductor can be determined.

13. The method according to claim 1, wherein the crimp device is controlled based on the control signal in such way that at least one control parameter of the crimp device for the crimping process is changed such that a non-defective crimp connection comprising a crimp element and a conductor to be processed by the crimp device is created.

14. A non-transitory computer readable medium comprising machine readable program code comprising control commands, which initiate in case of their execution an operation for crimping a crimp element to a conductor by a crimp device comprising a crimping tool and a crimp anvil, the operation comprising:
detecting at least one time-based signal relating to a crimping process performed by the crimp device;
analysing the at least one time-based signal by applying the at least one time-based signal to a trained neural network, wherein the trained neural network is configured to classify a result of the crimping process based on the at least one time-based signal;
providing, by the trained neural network, a classification result comprising at least a class corresponding to a non-defective crimp result and a class corresponding to a defective crimp result based on the classification performed by the trained neural network; and
generating a control signal based on the classification result.

15. The non-transitory computer readable medium according to claim 14, wherein the at least one time-based signal comprises at least one time-based force signal related to a force applied to a crimp element by the crimping tool, wherein the at least one time-based force signal is detected for a defined time period comprising a contact phase of the crimping tool and the crimp element.

16. The non-transitory computer readable medium according to claim 15, wherein at least one temperature signal is detected during the crimping process within or for a defined time-period comprising a contact phase of the crimping tool and the crimp element, wherein the temperature signal is an ambient temperature signal and is provided to the trained neural network, wherein the trained neural network is configured to consider the ambient temperature signal for classifying a result of the crimping process based on the at least one time-based signal and the ambient temperature signal.

17. The non-transitory computer readable medium according to claim 14, wherein the at least one time-based signal comprises at least one time-based structure-borne sound signal detected at least one of at the crimping tool, at the crimp anvil, or at a crimp anvil support, wherein the at least one time-based signal of structure-borne sound is detected during a relative movement of the crimping tool and the crimp anvil for a defined time period comprising a contact phase of the crimping tool and the crimp element.

18. A control unit comprising machine readable program code comprising control commands, which initiate in case of their execution an operation for crimping a crimp element to a conductor by a crimp device comprising a crimping tool and a crimp anvil, the operation comprising:
detecting at least one time-based signal relating to a crimping process performed by the crimp device;
analysing the at least one time-based signal by applying the at least one time-based signal to a trained neural network, wherein the trained neural network is configured to classify a result of the crimping process based on the at least one time-based signal;
providing, by the trained neural network, a classification result comprising at least a class corresponding to a non-defective crimp result and a class corresponding to a defective crimp result based on the classification performed by the trained neural network; and
generating a control signal based on the classification result.

19. The control unit of claim 18, wherein the at least one time-based signal comprises at least one time-based force signal related to a force applied to a crimp element by the crimping tool, wherein the at least one time-based force signal is detected for a defined time period comprising a contact phase of the crimping tool and the crimp element.

20. The control unit of claim 19, wherein at least one temperature signal is detected during the crimping process within or for a defined time-period comprising a contact phase of the crimping tool and the crimp element, wherein the temperature signal is an ambient temperature signal and is provided to the trained neural network, wherein the trained neural network is configured to consider the ambient temperature signal for classifying a result of the crimping process based on the at least one time-based signal and the ambient temperature signal.
